(19) United States
(12) Patent Application Publication
(10) Pub. No.: US 2004/0030877 A1
(43) Pub. Date: Feb. 12, 2004

(54) Using system BIOS to update embedded controller firmware

(76) Inventor: Aleksandr Frid, San Francisco, CA (US)

Correspondence Address: KIMBERLEY G. NOBLES, IRELL & MANELLA LLP, 840 NEWPORT CENTER DRIVE, SUITE 400, NEWPORT BEACH, CA, 92660, US

(21) Appl. No.: 10/213,550

(22) Filed: Aug. 6, 2002

(51) Int. Cl. G06F 9/00

(52) U.S. Cl. 713/1

(57) ABSTRACT

Systems, methods and software that update (flash) embedded controller firmware in production level computers under end-user operating system control, such as systems running a Windows operating system. An exemplary system comprises a central processing unit (CPU), a system memory, an embedded controller that comprises embedded controller firmware, and a BIOS storage area that stores initialization code comprising a basic input/output system (BIOS) that is operative to initialize the CPU and the system memory and which includes embedded controller firmware and a firmware update algorithm. Embedded controller firmware updating is implemented by comparing firmware identification data from the embedded controller with corresponding data in the BIOS, determining whether the embedded controller firmware in the embedded controller should be updated, and causing the BIOS to run the update algorithm and copy the embedded controller firmware from the BIOS storage area into the embedded controller to overwrite and update the embedded controller firmware therein. A flash utility is operative to write the updated embedded controller firmware from the firmware image file into the BIOS storage area.

### BACKGROUND

The present invention relates generally to computer system basic input/output systems (BIOS), and more particularly, to the use of system BIOS to update embedded controller firmware.

Existing applications for embedded controller firmware update require non-restricted and exclusive access to all embedded controller resources during flash updating. Therefore, current flash utilities need an operating system that does not limit API to embedded controllers, and allows utility to block any operating system task switching. Hence, existing embedded controller flash utilities can be run under the real address MS-DOS operating system but not under Windows operating systems.

As most modern personal computers are shipped with a Windows operating system that does not provide real address MS-DOS mode, existing embedded controller flash utilities cannot be used with production level personal computers to update embedded controller firmware in a “regular” end-user environment.

It is therefore an objective of the present invention is to provide for the use of system BIOS to update embedded controller firmware so that it can be re-flashed in production level computers under end-user operating system control.

### SUMMARY OF THE INVENTION

To accomplish the above and other objectives, the present invention provides for an ability to update (flash) embedded controller firmware in production level computers, such as personal computer systems, under end-user operating system (such as the Windows operating system) control. The present invention provides for systems, methods, and software that implement embedded controller firmware updating. The present invention also increases level of flash failure protection.

The present invention makes use of the fact that the basic input/output system (BIOS) of the computer system has non-limited and exclusive control of all personal computer hardware during start-up or booting of the personal computer. The present invention also makes use of the fact that system BIOS storage is not functional (and, therefore accessible) under the operating system.

An exemplary embodiment of the present invention comprises a central processing unit (CPU), a system memory, an embedded controller that comprises embedded controller firmware, and a BIOS storage area that stores initialization code comprising a basic input/output system (BIOS) that is operative to initialize the CPU and the system memory and which includes embedded controller firmware and a firmware update algorithm. The present invention is implemented using software and methods that provide embedded controller firmware updating.

The systems, software and methods compare firmware identification data from the embedded controller with corresponding data in the BIOS, determine whether the embedded controller firmware in the embedded controller should be updated, and cause the BIOS to run the update algorithm and copy the embedded controller firmware from the BIOS storage area into the embedded controller to overwrite and update the embedded controller firmware therein. A flash utility is operative to write the updated embedded controller firmware from a firmware image file into the BIOS storage area.

### BRIEF DESCRIPTION OF THE DRAWINGS

The various features and advantages of the present invention may be more readily understood with reference to the following detailed description taken in conjunction with the accompanying drawing figures, wherein like reference numerals designate like structural elements, and in which:

FIG. 1 is block diagram illustrating an exemplary personal computer system that embodies a embedded controller firmware updating method in accordance with the principles of the present invention;

FIG. 2 is a flow diagram illustrating an exemplary embedded controller firmware updating method and software code in accordance with the principles of the present invention; and

FIG. 3 is a flow diagram illustrating details of an exemplary implementation of the decision block of the exemplary embedded controller firmware updating method and software code shown in FIG. 2.

### DETAILED DESCRIPTION

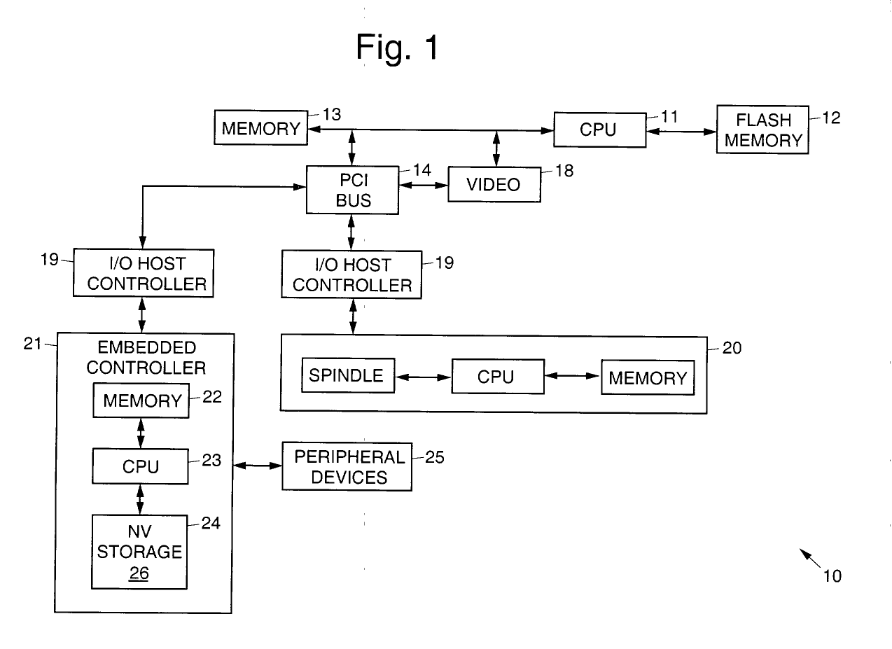

Referring to the drawing figures, FIG. 1 is block diagram illustrating an exemplary computer system 10, such as a personal computer system 10, that embodies a embedded controller firmware updating method 30 and software in accordance with the principles of the present invention. The computer system 10 comprises a central processing unit (CPU) 11 that is coupled to a critical nonvolatile storage device 12. The critical nonvolatile storage device 12 may be flash memory, a read only memory (ROM), a programmable read only memory (PROM), an erasable programmable read only memory (EPROM), an electrically erasable programmable read only memory (EEPROM), or other device or technology that the CPU 11 can use to execute an initial set of instructions.

The CPU 11 is also coupled to a system memory 13, such as a random access memory 13. The CPU 11 may be coupled to a secondary nonvolatile storage device 20 by way of a system bus 14, such as a Peripheral Component Interconnect (PCI) bus 14, for example, and an input/output (I/O) host controller 19. The secondary nonvolatile storage device 20 may be a hard disk drive, a compact disk (CD) drive, a digital video disk (DVD) drive, a floppy disk drive, a Zip drive, a SuperDisk drive, a magneto-optical disk drive, a Jazz drive, a high density floppy disk (HiFD) drive, flash memory, read only memory (ROM), programmable read only memory (PROM), erasable programmable read only memory (EPROM), electrically erasable programmable read only memory (EEPROM), or any other device or technology capable of preserving data in the event of a power-off condition.

The CPU 11 may be also coupled to an embedded controller (EC) 21 by way of a system bus 14, and I/O host controller 19. In modern computer systems the embedded controller 21 is commonly implemented as a universal microcontroller that includes its own memory 22, CPU 23, and nonvolatile (NV) storage device 24 or area 24 that stores embedded controller operating code 26, also known as embedded controller firmware 26.

The embedded controller 21 handles peripheral devices 25 such as a keyboard, a mouse, a battery, a set of end-user controlled buttons (such as power button and sleep button), or any other relatively slow I/O device that should be isolated from the main CPU 11 in order to prevent degradation of the overall system performance.

A first portion of the critical nonvolatile storage device 12 stores initialization code that is operative to initializes the CPU 11 and the system memory 13. A second portion of the critical nonvolatile storage device 12 stores a dispatch manager that contains a list of tasks, which must execute to fully initialize the computer system 10. The dispatch manager is operative to selectively load and iteratively execute a number of tasks relating to complete initialization of the computer.

In operation, when the computer system 10 is turned on, the initialization code is run to initialize the CPU 11 and the system memory 13. The dispatch manager is then loaded into the system memory 13. The dispatch manager executes the list of tasks contained therein to cause all required firmware (basic input/output system (BIOS) modules) to be loaded into the system memory 13 and must be executed.

The dispatch manager determines whether each required BIOS module in the system memory 13, and if it is not, finds, loads and executes each required BIOS module. The BIOS modules may be located in the critical nonvolatile storage device 12 (flash memory) or in the secondary nonvolatile storage device 20, including any of the critical or secondary nonvolatile storage devices 20 identified above. After all BIOS modules are executed the control of CPU 11 is transferred from the BIOS dispatch manger to an operating system, such as a Windows operating system.

Simultaneously with the main CPU 11, the embedded controller 21 executes firmware code 26 stored in the nonvolatile storage device 24 of the embedded controller 21 in order to handle the peripheral devices 25. Operation of the embedded controller 21 is necessary not only during computer system initialization but also after control is transferred to operating system.

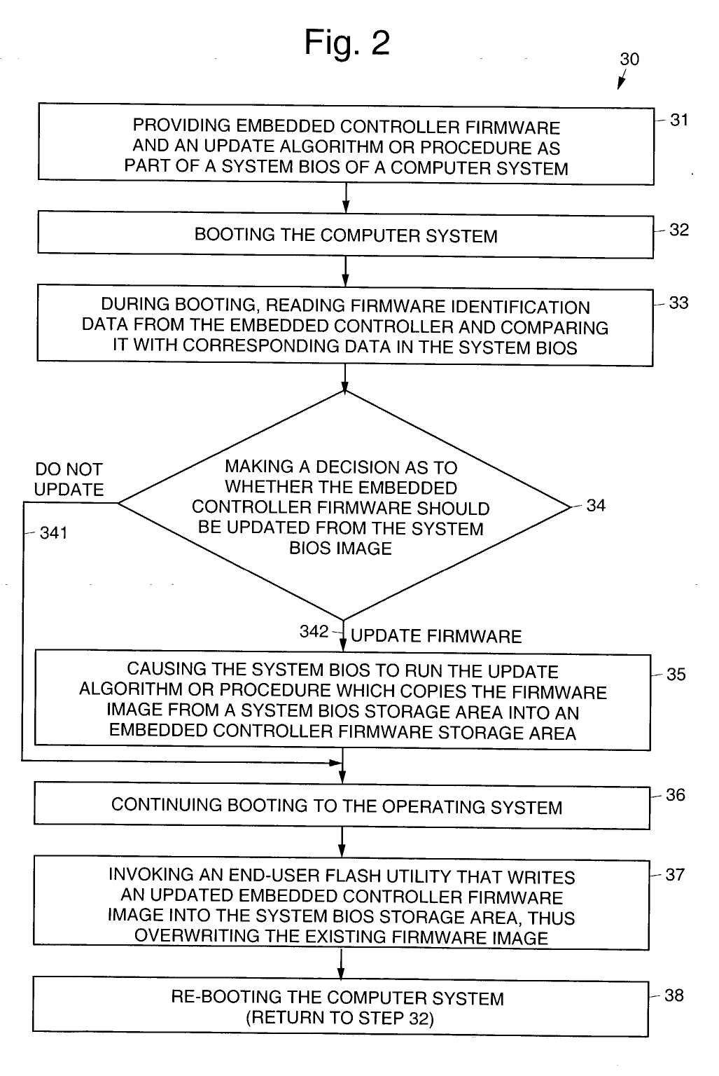

Referring now to FIG. 2, it is a flow diagram illustrating an exemplary embedded controller firmware updating method 30 in accordance with the principles of the present invention. The exemplary embedded controller firmware updating method 30 is used with a (personal) computer system 10 having a basic input/output system (BIOS) and running an operating system, such as a Windows operating system. The exemplary embedded controller firmware updating method 30 comprises the following steps.

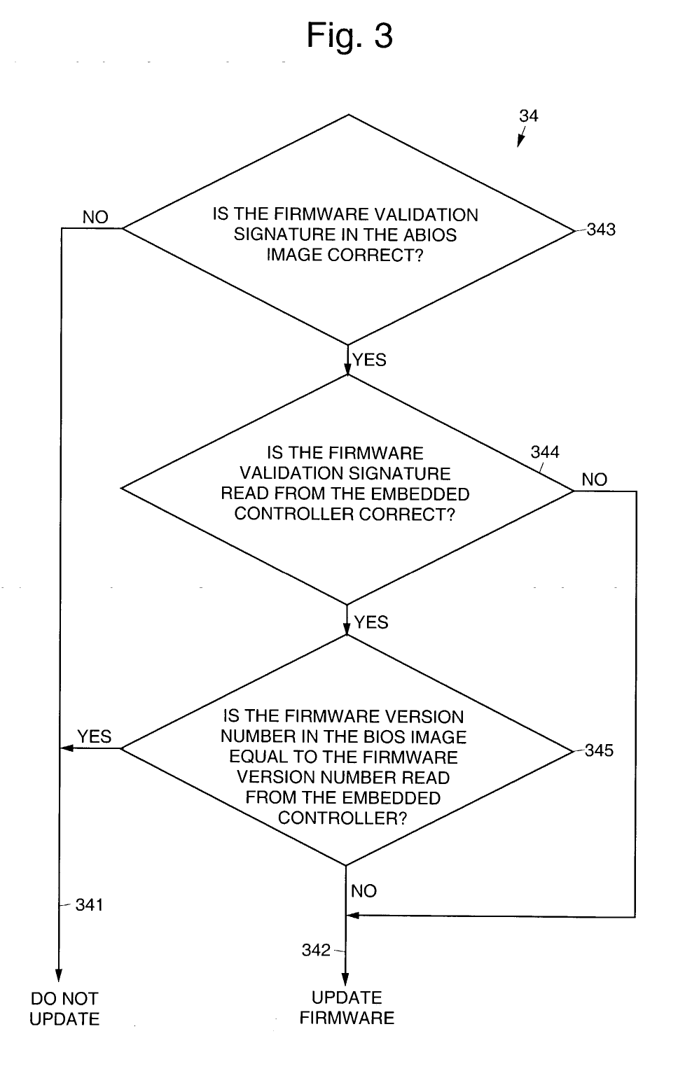

An embedded controller firmware image as well as a firmware update algorithm or procedure are provided 31 as part of the BIOS. The computer system 10 is booted 32. During booting, or start-up, the system BIOS reads 33 firmware identification data from the embedded controller 21 and compares it with corresponding data in the firmware image that is part of the BIOS. This firmware identification data may be a fixed firmware validation signature, a checksum of the entire firmware image, a firmware version number, a firmware build time-stamp, or any other data that can identify embedded controller firmware 26. Based on the comparison results, the system BIOS makes a decision 34 (see also FIG. 3) as to whether embedded controller firmware 26 should be updated.

If a Yes decision 342 is made, the system BIOS carries out 35 or runs 35 the update algorithm or procedure which copies the new firmware image from the system BIOS stored in the critical nonvolatile storage device 12 into the embedded controller firmware storage device 24. Then the system BIOS continue booting 36 to the operating system.

If a No decision 341 is made, the system BIOS continues booting 36 to the operating system.

After booting 36 to the operating system, the end-user can invoke a flash utility, such as a Windows flash utility, which writes 37 the new firmware image from the image file into the system BIOS storage area 12 (critical nonvolatile storage device 12) of the computer system 10. Then computer system 10 is then re-booted 38.

The firmware image file is an external file that contains updated embedded controller firmware that is sent to the end user by the manufacturer of the computer system 10 if the embedded controller firmware needs to be updated. The updated firmware image file may be copied onto the secondary nonvolatile storage device 20 or made available on a floppy drive or as an e-mail attachment, for example, so that it is readable by the flash utility. When the end user invokes the flash utility, it copies 37 this new firmware image file to the BIOS storage area (critical nonvolatile storage device 12), thus overwriting the existing firmware. Then after re-boot, the system BIOS copies 35 the updated firmware from the BIOS storage area (critical nonvolatile storage device 12) into the embedded controller 21, also overwriting the existing firmware in the embedded controller firmware storage device 24.

Referring now to FIG. 3, it is a flow diagram illustrating an exemplary implementation of the decision block 34 of the exemplary embedded controller firmware updating method 30 and software code shown in FIG. 2.

Normally during computer system booting both the embedded controller firmware images in the system BIOS storage area 12 and in the embedded controller firmware storage device 24 are the same. Therefore, the decision path follows decision block 343-YES exit, decision block 344-YES exit and decision block 345-YES exit to the No decision 341-DO NOT UPDATE. In this case, the computer system 10 directly boots to the operating system that allows the end-user to invoke the flash utility. After the flash utility writes a new firmware image with a new version number into the system BIOS storage area 12, and re-boots the personal computer system 10, the decision path follows decision block 343-YES exit, decision block 344-YES exit, and decision block 345-NO exit to the Yes decision 342-UPDATE FIRMWARE. As a result the system BIOS carries out 35, and the new firmware image from the system BIOS storage area 12 is copied into the embedded controller firmware storage device 24. This completes the two-part update of the embedded controller firmware 26 in the production level computers under end-user operating system control.

Because the embedded controller firmware image is provided 31 as part of the BIOS, the flash utility can update 37 system BIOS and embedded controller firmware simultaneously from one common image file.

If the flash utility fails when executing the update 37, the validation signature of the firmware image in the BIOS storage area 12 is invalid, and the decision path follows decision block 343-NO exit to the No decision 341-DO NOT UPDATE. Hence, the embedded controller 21 continues to operate from the old firmware storage device 24. The computer system 10 boots to the operating system, and the end-user can invoke the flash utility again to recover from the flash failure. If the flash fails while running the update algorithm 35 the firmware image in storage device 24 is invalid, and the computer system 10 cannot boot to the operating system. However, during the next power-up boot, the decision path follows decision block 343-YES exit and decision block 344-NO exit to the Yes decision 342-UPDATE FIRMWARE. Hence, update 35 is executed again providing recovery from the flash failure. This increases flash failure protection.

The present invention may be implemented because the computer system BIOS has non-limited and exclusive control of all hardware components of the personal computer system 10 during start-up or booting, and because system BIOS storage is not functional (and, therefore accessible) under the operating system.

The present invention allows updating embedded controller firmware 26 in production level personal computers under end-user operating system (Windows) control. The present invention also allows simultaneous update of the system BIOS and embedded controller firmware if necessary. The present invention also increases level of flash failure protection.

The present invention thus provides for systems, methods, and software that implement embedded controller firmware updating. More particularly, the present invention provides the ability to update (flash) embedded controller firmware 26 in production level personal computers under end-user operating system (Windows) control.

The present invention preferably provides for software for use on a computer 10 having a basic input/output system (BIOS) running a Windows operating system. The software implements embedded controller firmware updating of the computer 10.

The software includes a code section that comprises embedded controller firmware 26 which provides the system BIOS with access to firmware identification data. The software includes a code section that is part of the BIOS that boots the computer 10. The software includes a code section that causes the system BIOS to read firmware identification data from the embedded controller, compare it with the respective data in the system BIOS storage and make a decision on whether embedded controller firmware 26 should be copied from the system BIOS storage into the embedded controller 21.

The software includes a code section that causes the system BIOS to run the update algorithm or procedure during re-booting of the computer system 10, which update algorithm or procedure writes the new firmware image into an embedded controller firmware storage device 24 of the computer system 10.

The software includes flash utility, such as the Windows flash utility, that can be invoked by the end-user after personal computer system boot to the operating system, such as Windows, in order to write a new embedded controller firmware image and update algorithm from the firmware image file into a system BIOS storage area 12.

Thus, systems, methods, and software that implement embedded controller firmware updating have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A system that provides for embedded controller firmware updating, comprising:
(1) a central processing unit (CPU);
(2) a system memory coupled to the CPU;
(3) a BIOS storage area coupled to the CPU that stores initialization code comprising a basic input/output system (BIOS) that is operative to initialize the CPU and the system memory and which includes embedded controller firmware and a firmware update algorithm;
(4) an embedded controller coupled to the CPU that comprises embedded controller firmware; and
(5) software that provides embedded controller firmware updating that comprises:
a flash utility that is operative to write updated embedded controller firmware into the BIOS storage area that overwrites the existing firmware image;
a code segment that compares firmware identification data from the embedded controller with corresponding data in the BIOS;
a code segment that determines whether the embedded controller firmware in the embedded controller should be updated; and
a code segment that causes the BIOS to run the update algorithm and copy the embedded controller firmware from the BIOS storage area into the embedded controller to overwrite and update the embedded controller firmware therein.

2. The system recited in claim 1 wherein the flash utility comprises a flash utility that runs under a Windows operating system.

3. The system recited in claim 1 wherein the code section that determines whether the embedded controller firmware in the embedded controller should be updated comprises:
a code segment that determines if a firmware validation signature in the BIOS is correct;
a code segment that, if the firmware validation signature in the BIOS is correct, determines if a firmware validation signature in the embedded controller is correct, and if it is not correct, allows the update algorithm to be run; and
a code segment that, if the firmware validation signature is correct, determines if a version number in the BIOS matches the firmware version number read from the embedded controller, and if it does not match, allows the update algorithm to be run.

4. A method for use with a computer system having a basic input/output system (BIOS), an operating system, and an embedded controller comprising embedded controller firmware, which method provides for embedded controller firmware updating, and which comprises the steps of:
providing embedded controller firmware and a firmware update algorithm as part of the BIOS;
booting the computer system;
invoking a flash utility to write updated embedded controller firmware into the BIOS storage area that overwrites the existing firmware image;
comparing firmware identification data from the embedded controller with corresponding data in the BIOS;
determining whether the embedded controller firmware in the embedded controller should be updated; and
running the update algorithm to copy the embedded controller firmware from the BIOS into the embedded controller to overwrite and update the embedded controller firmware.

5. The method recited in claim 4 wherein the operating system is a Windows operating system, and the flash utility is one that runs under a Windows operating system.

6. The method recited in claim 4 wherein the step of determining whether the embedded controller firmware in the embedded controller should be updated comprises the steps of:
determining if a firmware validation signature in the BIOS is correct;
if the firmware validation signature in the BIOS is correct, determining if a firmware validation signature in the embedded controller is correct, and if it is not correct, running the update algorithm; and
if the firmware validation signature is correct, determining if a version number in the BIOS matches the firmware version number read from the embedded controller, and if it does not match, running the update algorithm.

7. Software, for use with a computer system having a basic input/output system (BIOS), an operating system, and an embedded controller comprising embedded controller firmware, which software provides embedded controller firmware updating, comprising:
a BIOS code segment that comprises embedded controller firmware;
a BIOS code segment that comprises a firmware update algorithm;
a code segment that boots the computer;
a flash utility code segment that writes updated embedded controller firmware into the BIOS storage area that overwrites the existing firmware image;
a code segment that compares firmware identification data from the embedded controller with corresponding data in the BIOS;
a code segment that determines whether the embedded controller firmware in the embedded controller should be updated; and
a code segment that runs the update algorithm to copy the embedded controller firmware from the BIOS into the embedded controller to overwrite and update the embedded controller firmware.

8. The software recited in claim 7 wherein the operating system is a Windows operating system, and the flash utility is one that runs under a Windows operating system.

9. The software recited in claim 7 wherein the code section that determines whether the embedded controller firmware in the embedded controller should be updated comprises:
a code segment that determines if a firmware validation signature in the BIOS is correct;
a code segment that, if the firmware validation signature in the BIOS is correct, determines if a firmware validation signature in the embedded controller is correct, and if it is not correct, allows the update algorithm to be run; and
a code segment that, if the firmware validation signature is correct, determines if a version number in the BIOS matches the firmware version number read from the embedded controller, and if it does not match, allows the update algorithm to be run.
